(19) United States
(12) Patent Application Publication
(10) Pub. No.: US 2022/0221744 A1
(43) Pub. Date: Jul. 14, 2022

(54) INTEGRATED COMPACT Z-CUT LITHIUM NIOBATE MODULATOR

(71) Applicant: Zhuohui CHEN, Ottawa (CA)

(72) Inventor: Zhuohui CHEN, Ottawa (CA)

(21) Appl. No.: 17/148,076

(22) Filed: Jan. 13, 2021

(51) Int. Cl. G02F 1/035

(52) U.S. Cl. CPC G02F 1/035; G02F 2202/20

(57) ABSTRACT

A Z-cut lithium niobate (LiNbO₃)-based modulator may include: a base substrate; a ground electrode deposited on the base substrate; a first cladding layer on top of the base substrate; an optical waveguide core on top of the first cladding layer; a second cladding layer on top of the optical waveguide; and a signal electrode deposited on top of the second cladding layer; where the optical waveguide core includes a Z-cut LiNbO₃, and where the first cladding layer, the optical waveguide, and the second cladding layer are positioned between the ground electrode and the signal electrode on a z-axis of the Z-cut LiNbO₃.

### RELATED APPLICATIONS

This is the first patent application for the present disclosure.

### TECHNICAL FIELD

The present application relates to electro-optic modulators used in optical communication networks, and in particular to Z-cut lithium niobate electro-optic modulators.

### BACKGROUND

In modern telecommunication systems, optical communication networks can be used to send and receive payload information in the form of optical signals transmitted through components (e.g., amplifier, multiplexer/de-multiplexer, waveguides) and optical fibers connecting the components.

In an optical communication network, there is often a need to encode a signal onto an optical beam, which is then transmitted through optical fibers to a distant destination. An electro-optic modulator, which can modulate a beam of light, may be used to encode information onto a continuous light wave, which can be generated by a laser source.

An example electro-optic modulator, used in an optical system may be a lithium niobate electro-optic modulator, such as, for example, a lithium niobate piezoelectric-optical modulator. Lithium niobate (LiNbO₃), when in crystal form, may have a refractive index as a function of the strength of a local electric field or an applied voltage. Lithium niobate is characterized by its Pockels effect, which changes or produces birefringence in an optical medium induced by an electric field. In the Pockels effect, also known as the linear electro-optic effect, the birefringence is proportional to the electric field.

A basic yet important element in the LiNbO₃-based modulator is the optical waveguide, which is often evaluated based on propagation losses and electro-optical conversion efficiency.

There are several ways of manufacturing a LiNbO₃ electro-optic modulator, such as, for example, by metal diffusion, ion exchange, or proton exchange. These conventional manufacturing methods, however, often produce a modulator that has a rather small refractive index change in the waveguide crystal (e.g. LiNbO₃).

FIG. 1A illustrates a cross-sectional view of a prior art X-cut LiNbO₃ electro-optic modulator 100 with coplanar waveguide (CPW) radio-frequency electrodes, as discussed in Wooten, E. L. et. al, (2000). A Review of Lithium Niobate Modulators for Fiber-Optic Communications Systems. Selected Topics in Quantum Electronics, IEEE Journal of. 6. 69-82. 10.1109/2944.826874, the entire content of which is herein incorporated by reference.

Conventionally, X-cut manufacturing technology is used to make the LiNbO₃ waveguide in the modulator 100, which can be formed with: Titanium (Ti) metal diffusion (at approximately 1000° C.), ion exchange, or proton exchange. Gold (Au) is generally used as the material for electrodes. Electrodes can be fabricated either directly on the surface of the LiNbO₃ wafer (or also known as LiNbO₃ substrate), or on an optically transparent buffer layer to reduce optical loss due to metal loading. In general, an adhesion layer, such as Titanium (Ti), is first vacuum deposited on the wafer, followed by the deposition of a base layer of the metal in which the electrodes are to be made.

FIG. 1B illustrates a cross-sectional view of another prior art LiNbO₃ electro-optic modulator 150, as shown in Shawn Y. Siew, et. al, “Integrated nonlinear optics: lithium niobate-on-insulator waveguides and resonators,” Proc. SPIE 10106, Integrated Optics: Devices, Materials, and Technologies XXI, 101060B (16 Feb. 2017), the entire content of which is herein incorporated by reference. Modulator 150 has a ridge waveguide made with LiNbO₃ deposited on top of a thin layer of silicon dioxide (SiO₂). The manufacturing process uses a Pieozoelectric-On-Insulator (POI) wafer bonding technology.

FIG. 3A illustrates a cross-sectional view of yet another prior art LiNbO₃ electro-optic modulator 300, which is described in Cheng Wang, et. al, Integrated lithium niobate electro-optic modulators operating at CMOS-compatible voltages. Nature. 2018 October; 562(7725):101-104. doi: 10.1038/s41586-018-0551-y. Epub 2018 Sep. 24. PMID: 30250251, the entire content of which is herein incorporated by reference. FIG. 3A shows a monolithically integrated lithium niobate electro-optic modulator 300 that features a CMOS-compatible drive voltage. Optical lithium niobate waveguides run through the dielectric gaps of the Ground-Signal-Ground (GSG) coplanar microwave strip line. As a result, the microwave electric field has opposite signs across the two lithium niobate waveguides, thus inducing (via the Pockels effect) an optical phase delay on one arm and an optical phase advance on the other. The modulator 300 can be fabricated from a commercial X-cut lithium-niobate-on-insulator wafer, where a 600-nm device layer sits on top of a SiO2/Si-stack substrate. Electron-beam lithography and Ar+ ion based reactive ion etching can be carried out to define optical waveguides and Mach-Zehnder interferometers in thin-film lithium niobate.

Generally speaking, the drawbacks of the conventional X-cut LiNbO₃ electro-optic modulators 100, 150, 300 may include: a relatively small refractive index contrast between core and cladding, or a relatively large waveguide length, which can be up to several centimeters long, and a weak optical energy confinement.

### SUMMARY

The present disclosure describes various designs of a lithium niobate (LiNbO₃)-based modulator and various methods for manufacturing the lithium niobate (LiNbO₃)-based modulators. In accordance with some aspects, an example LiNbO₃-based modulator may include: a base substrate; a ground electrode deposited on the base substrate; a first cladding layer on top of the base substrate; an optical waveguide core on top of the first cladding layer; a second cladding layer on top of the optical waveguide core; and a signal electrode deposited on top of the second cladding layer; where the optical waveguide core includes a Z-cut LiNbO₃, and where the first cladding layer, the optical waveguide core, and the second cladding layer are positioned between the ground electrode and the signal electrode on a z-axis of the Z-cut LiNbO₃.

The disclosed modulator designs, in some example embodiments, are configured to provide a relatively large refractive index change (Δn) in the optical waveguide. In doing so, the confinement of light is strong and the optic mode size is small, which may result in a relatively small half-wave voltage in the Mach Zehnder modulator's VπL. Since the nonlinear wave mixing efficiency is directly proportional to the light intensity in the waveguide, higher confinement and smaller mode size can result in a modulator with better electro-optical efficiency. Furthermore, due to a large refractive index difference, and less optical energy leakage, bending the waveguide (e.g., for optical ring resonator application) with a radius of curvature of less than a few millimeters is possible.

In addition, the proposed piezo-electro-optic can be CMOS compatible, which makes it possible to integrate the optical device with other electronic components on the same wafer.

In some embodiments, the base substrate may include a silicon (Si) substrate.

In some embodiments, the optical waveguide core may include a ridge portion.

In some embodiments, the ridge portion may be made of Z-cut LiNbO₃ or tantalum pentoxide (Ta₂O₅).

In some embodiments, the distance between a top surface of the ground electrode and a bottom surface of the signal electrode on the z-axis of the Z-cut LiNbO₃ is equal to or less than 1 micrometer (μm).

In some embodiments, the first cladding layer may include silicon dioxide (SiO₂).

In some embodiments, the second cladding layer may include silicon dioxide (SiO₂).

In some embodiments, the ground electrode may include one of:
gold, copper, titanium, zinc, silver, aluminum and platinum.

In some embodiments, the signal electrode may include one of:
gold, copper, titanium, zinc, silver, aluminum and platinum.

In some embodiments, the modulator may include a third cladding layer between the ground electrode and the base substrate.

In some embodiments, the third cladding layer may include SiO₂.

In some embodiments, the ground electrode may be embedded within the base substrate.

In some embodiments, the ground electrode may have a width that is equal to a width of the signal electrode.

In some embodiments, the ground electrode may have a width that is equal to a width of the ridge portion of the optical waveguide core.

In some embodiments, a distance between a bottom surface of the signal electrode and a top surface of the optical waveguide core is between 50 nanometers (nm) to 200 nm.

In some embodiments, a thickness of the first cladding layer is between 200 nm to 600 nm.

In some embodiments, the modulator may have a second arm, where the second arm may include: the first base substrate; a second ground electrode deposited on the first base substrate; a third cladding layer on top of the first base substrate; a second optical waveguide core on top of the third cladding layer; a fourth cladding layer on top of the second optical waveguide core; and a second signal electrode deposited on top of the fourth cladding layer; where the second optical waveguide core includes a second Z-cut LiNbO₃, and where the third cladding layer, the second optical waveguide core, and the fourth cladding layer are positioned between the second ground electrode and the second signal electrode on a z-axis of the second Z-cut LiNbO₃.

In some embodiments, the second optical waveguide core may include a ridge portion made of Z-cut LiNbO₃ or tantalum pentoxide (Ta₂O₅).

In some embodiments, the distance between a top surface of the second ground electrode and a bottom surface of the second signal electrode on the z-axis of the second Z-cut LiNbO₃ is equal to or less than 1 micrometer (μm).

In some embodiments, a distance between a bottom surface of the second signal electrode and a top surface of the second optical waveguide core is between 50 nanometers (nm) to 200 nm.

In some embodiments, a thickness of the third cladding layer is between 200 nm to 600 nm.

In some embodiments, the second ground electrode is embedded within the first base substrate.

In accordance with some aspects, there is disclosed a method of manufacturing a lithium niobate (LiNbO₃)-based modulator. The method may include: depositing a metal on a base substrate to form a ground electrode; depositing silicon dioxide (SiO₂) on one side of a Z-cut LiNbO₃ wafer to form a first cladding layer; implanting an oxide side of the Z-cut LiNbO₃ wafer with ions; wafer bonding the ion-implanted side of the Z-cut LiNbO₃ wafer with the base substrate; removing a donor layer of the Z-cut LiNbO₃ wafer; dry etching, on the Z-cut LiNbO₃ wafer, with a photoresist mask to obtain a ridge portion of the Z-cut LiNbO₃ wafer; depositing silicon dioxide (SiO₂) on the Z-cut LiNbO₃ wafer to form a second cladding layer surrounding the ridge portion; and depositing a metal on the second cladding layer to form a signal electrode; where the ground electrode and the signal electrode are spaced apart and positioned on a z-axis of the Z-cut LiNbO₃.

In some embodiments, the base substrate may include a silicon (Si) substrate.

In some embodiments, the ground electrode or signal electrode may include but not restrict to one or a combination of: gold, copper, titanium, zinc, silver, aluminum and platinum.

In some embodiments, the method may further include: cleaning the base substrate prior to depositing the metal on the base substrate to form the ground electrode.

In some embodiments, the oxide side of the Z-cut LiNbO3 wafer may be ion-implanted with helium or hydrogen ions.

In some embodiments, the distance between the ground electrode and the signal electrode on the z-axis of the Z-cut LiNbO3 is equal to or less than 1 micrometer (μm).

### BRIEF DESCRIPTION OF THE DRAWINGS

The patent or application file contains at least one drawing executed in color. Copies of this patent or patent application publication with color drawing will be provided by the Office upon request and payment of the necessary fee.

Reference will now be made, by way of example, to the accompanying figures which show example embodiments of the present application, and in which:

FIG. 1A illustrates a cross-sectional view of a prior art LiNbO₃ electro-optic modulator.

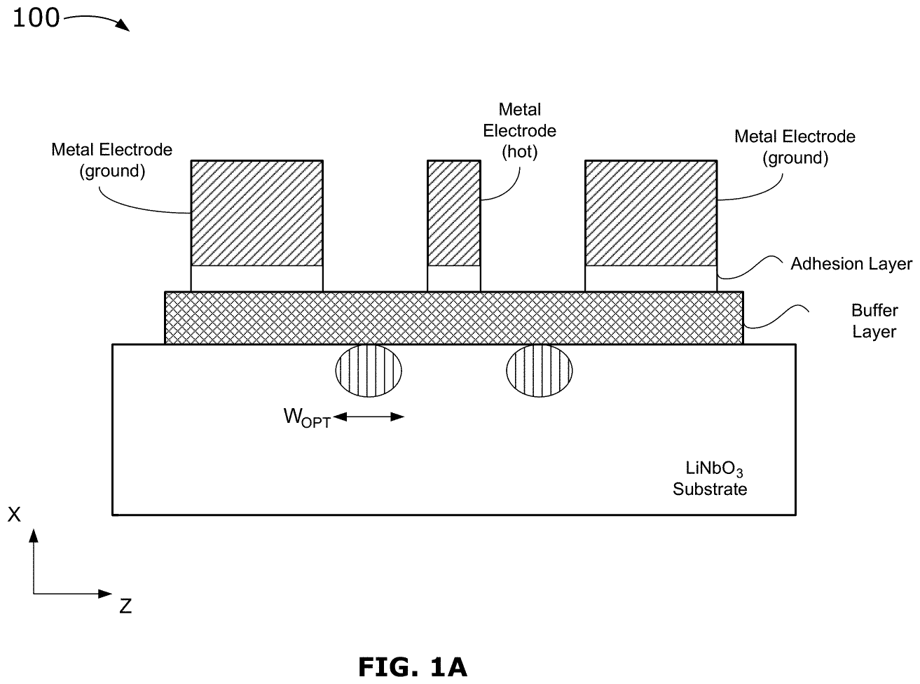

FIG. 1B illustrates a cross-sectional view of another prior art LiNbO₃ electro-optic modulator.

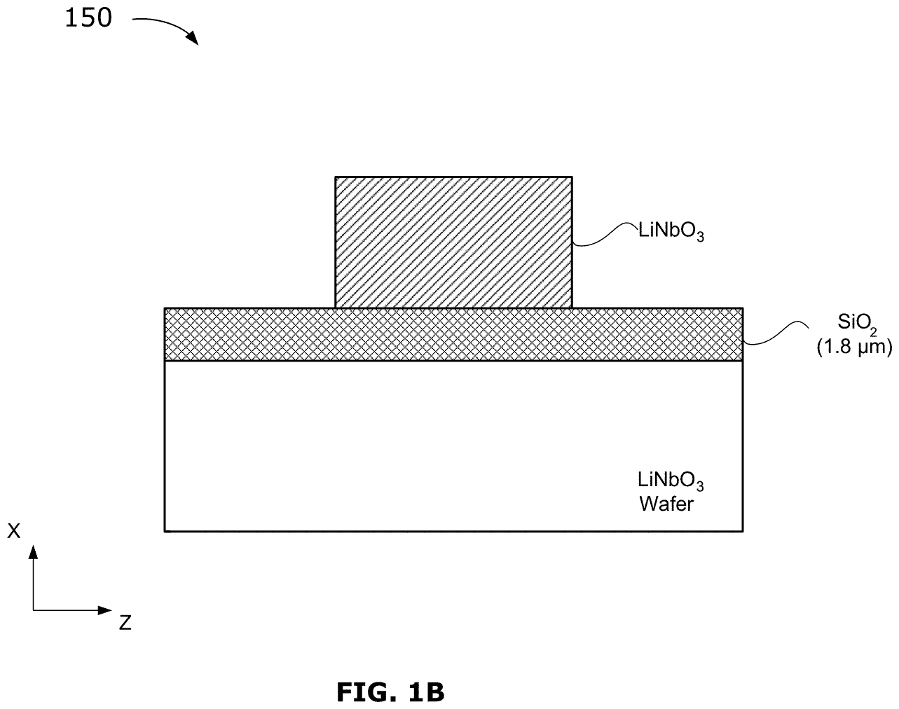

FIG. 2 illustrates a simplified view of an example LiNbO₃ with crystal axes.

FIG. 3A illustrates a cross-sectional view of yet another prior art LiNbO₃ electro-optic modulator.

FIG. 3B illustrates a radio-frequency (RF) electric field graph of the LiNbO₃ electro-optic modulator in FIG. 3A.

FIG. 4A illustrates a cross-sectional view of an example arm of a first example Z-cut LiNbO₃ electro-optic modulator, in accordance with some example embodiments.

FIG. 4B illustrates a radio-frequency (RF) electric field graph of the first example Z-cut LiNbO₃ electro-optic modulator, in accordance with some example embodiments.

FIG. 4C illustrates an optical power flow graph of the first example Z-cut LiNbO₃ electro-optic modulator, in accordance with some example embodiments.

FIG. 4D illustrates a stress graph of the first example Z-cut LiNbO₃ electro-optic modulator, in accordance with some example embodiments.

FIG. 4E illustrates an effective refractive index of the first example Z-cut LiNbO₃ waveguide as a buffer layer thickness increases, in accordance with some example embodiments.

FIG. 4F illustrates an electric field within the first example Z-cut LiNbO₃ waveguide as a buffer layer thickness increases, in accordance with some example embodiments.

FIG. 4G illustrates an effective refractive index of the first example Z-cut LiNbO₃ waveguide as a bottom layer thickness increases, in accordance with some example embodiments.

FIG. 4H illustrates an electric field within the first example Z-cut LiNbO₃ waveguide as a bottom layer thickness increases, in accordance with some example embodiments.

FIG. 5 illustrates a cross-sectional view of an example arm of a second example Z-cut LiNbO₃ electro-optic modulator, in accordance with some example embodiments.

FIG. 6 illustrates a cross-sectional view of an example arm of a third example Z-cut LiNbO₃ electro-optic modulator, in accordance with some example embodiments.

FIG. 7A illustrates a cross-sectional view of an example arm of a fourth example Z-cut LiNbO₃ electro-optic modulator, in accordance with some example embodiments.

FIG. 7B illustrates a radio-frequency (RF) electric field graph of the fourth example Z-cut LiNbO₃ electro-optic modulator, in accordance with some example embodiments.

FIG. 7C illustrates an optical power flow graph of the fourth example Z-cut LiNbO₃ electro-optic modulator, in accordance with some example embodiments.

FIG. 8 illustrates a cross-sectional view of an example arm of a fifth Z-cut LiNbO₃ electro-optic modulator, in accordance with some example embodiments.

FIG. 9 is a flow chart illustrating an example method to manufacture the first example Z-cut LiNbO₃ electro-optic modulator, in accordance with some example embodiments.

FIG. 10 is a flow chart illustrating an example method to manufacture the second example Z-cut LiNbO₃ electro-optic modulator, in accordance with some example embodiments.

Like reference numerals are used throughout the Figures to denote similar elements and features. While aspects of the invention will be described in conjunction with the illustrated embodiments, it will be understood that it is not intended to limit the invention to such embodiments.

### DETAILED DESCRIPTION OF EXAMPLE EMBODIMENTS

Throughout this disclosure, the term “coupled” may mean directly or indirectly connected, electrically coupled, or operably connected; the term “connection” may mean any operable connection, including direct or indirect connection. In addition, the phrase “coupled with” is defined to mean directly connected to or indirectly connected through one or more intermediate components. Such intermediate components may include both or either of hardware and software-based components.

Further, a communication interface may include any operable connection. An operable connection may be one in which signals, physical communications, and/or logical communications may be sent and/or received. An operable connection may include a physical interface, an electrical interface, and/or a data interface.

Further, a communication interface may include any operable connection. An operable connection may be one in which signals, physical communications, and/or logical communications may be sent and/or received. An operable connection may include a physical interface, an electrical interface, and/or a data interface.

In general, electro-optical modulators, such as, for example, Mach Zehnder (MZ) modulators, can be fabricated with either X-cut or Z-cut LiNbO₃. X-cut LiNbO₃ modulators have a symmetrical design, which may result in a low frequency-chirp in the modulated signal, while Z-cut LiNbO₃ modulators may provide more efficient modulation (i.e., lower Vπ or half-wave voltage) at the expense of a higher frequency chirp. The half-wavelength voltage Vπ is the voltage required for inducing a phase change of π for the light going through the waveguide of the modulator. Generally speaking, the phase of the light leaving the waveguide can be controlled by changing the electric field in the LiNbO₃ waveguide.

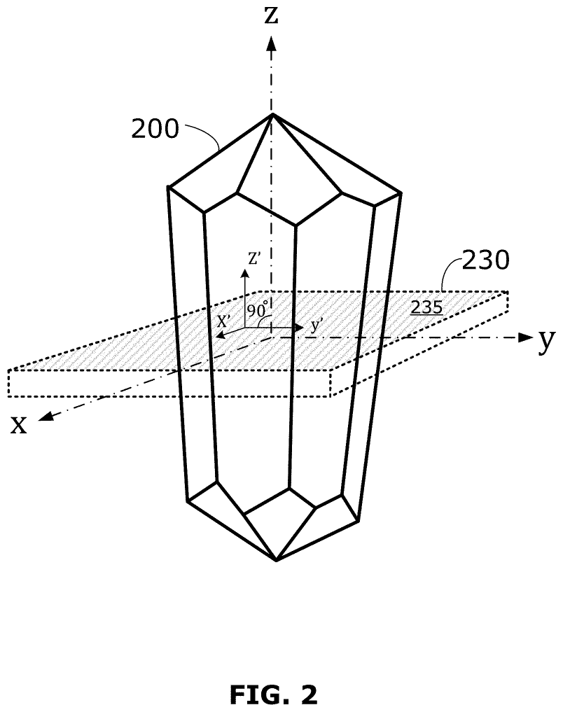

It is to be appreciated that the x-axis, y-axis, and z-axis discussed throughout this disclosure, including in the drawings, refer to the crystal axes of a z-cut LiNbO₃. Referring now to FIG. 2, which illustrates a simplified view of an example LiNbO₃ 200 with crystal axes x, y, z. A Z-cut (or z-cut) LiNbO₃ wafer 230 can be obtained by cutting the crystal 200 across a surface or plane that is perpendicular to its z-axis. For example, the Z-cut LiNbO₃ wafer 230 has a top surface 235. The z′-axis of the Z-cut LiNbO₃ wafer 230 is normal to the surface 235, while the x′-axis and y′-axis lie within the surface 235. As shown, the x′-axis of the Z-cut LiNbO₃ wafer 230 is perpendicular to the z-axis of the crystal LiNbO₃.

In some example electro-optical modulators, a Mach-Zehnder interferometer (MZI) modulator may have two arms for modulation, where both arms are manufactured on the same base substrate. Each arm may include an optical waveguide (or simply referred to as a “waveguide”). A waveguide may include a longitudinally extended high-index optical medium, which may be known as the “core”, made with LiNbO₃ (or a different material). The high-index optical medium core may be transversely surrounded by a low-index media, which may be known as the “cladding”, made with silicon dioxide (SiO₂). A guided optical wave propagates in the waveguide core along its longitudinal direction.

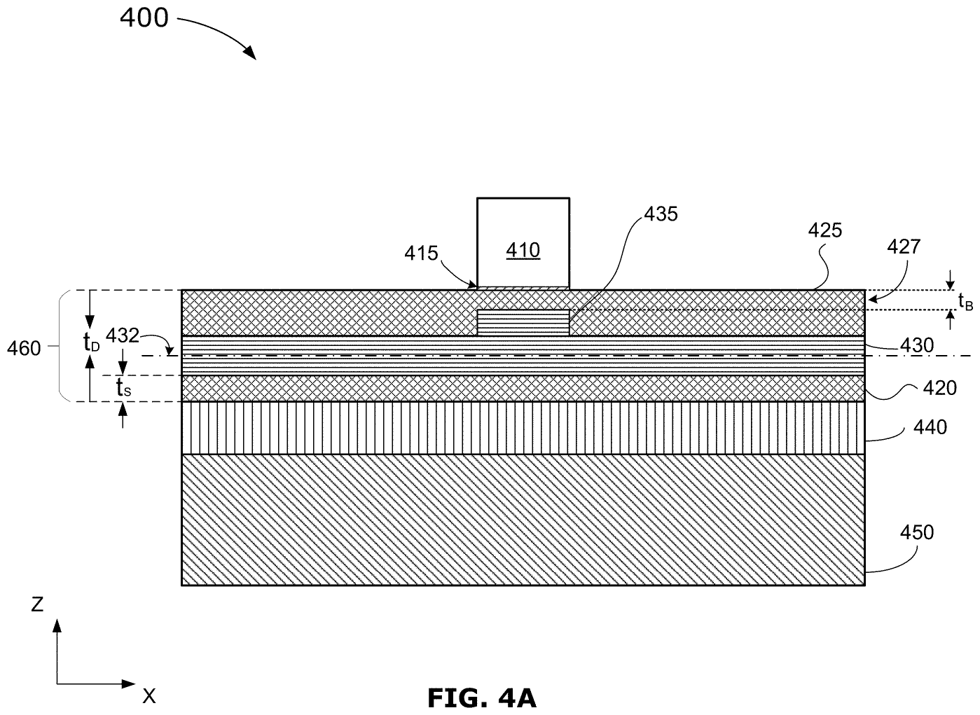

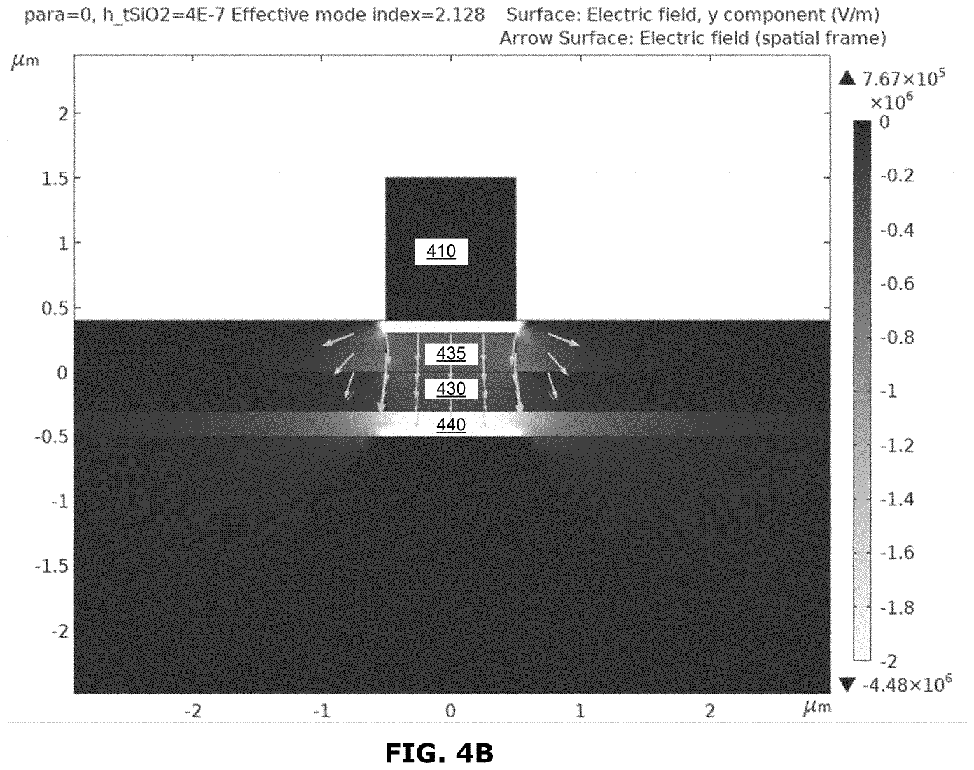

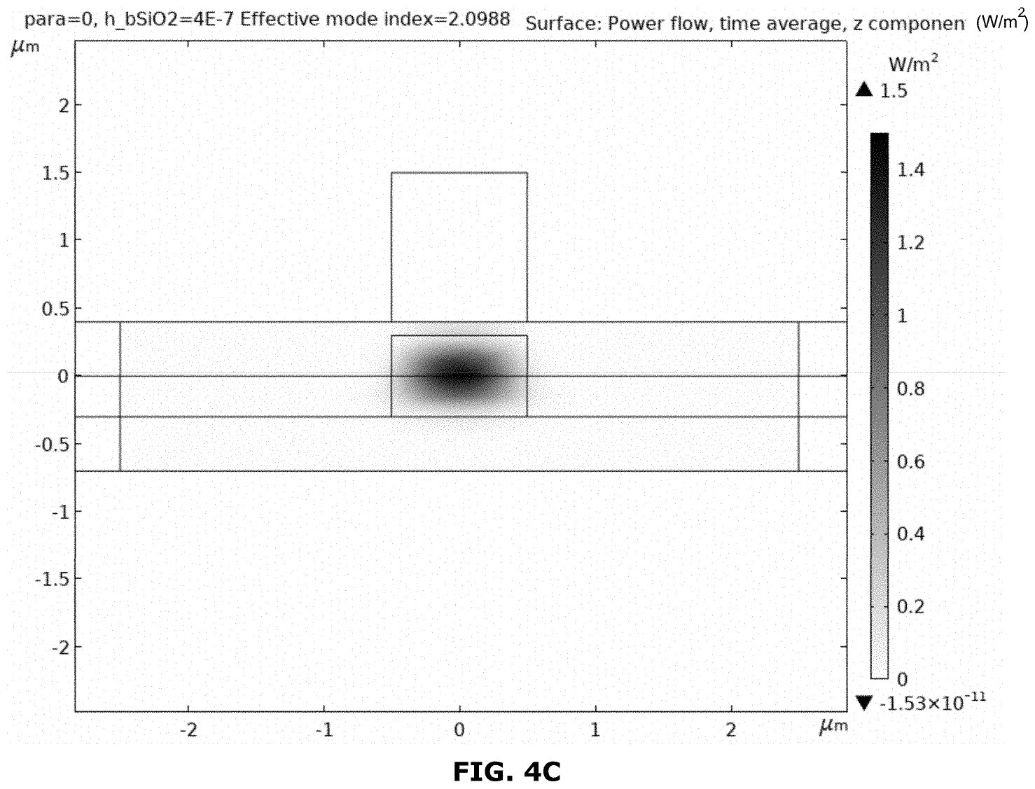

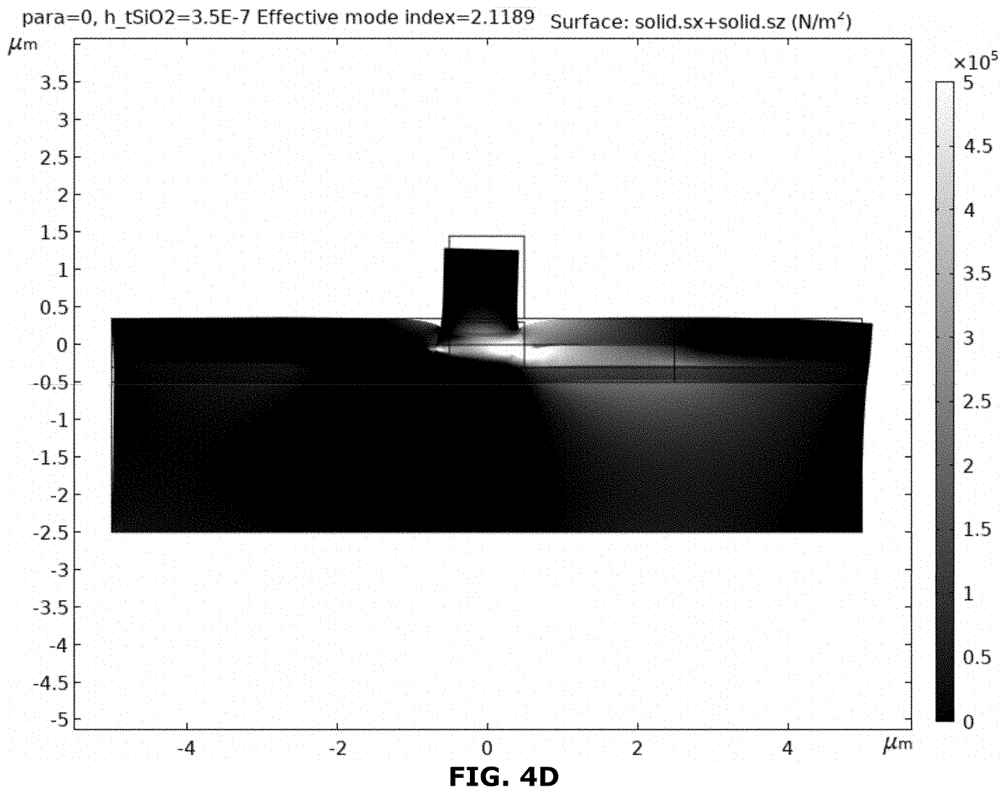

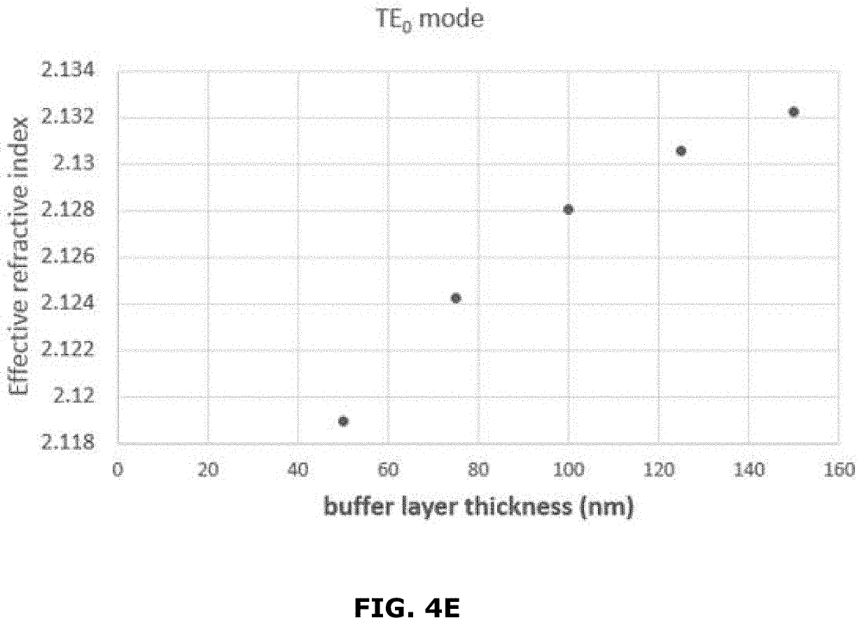

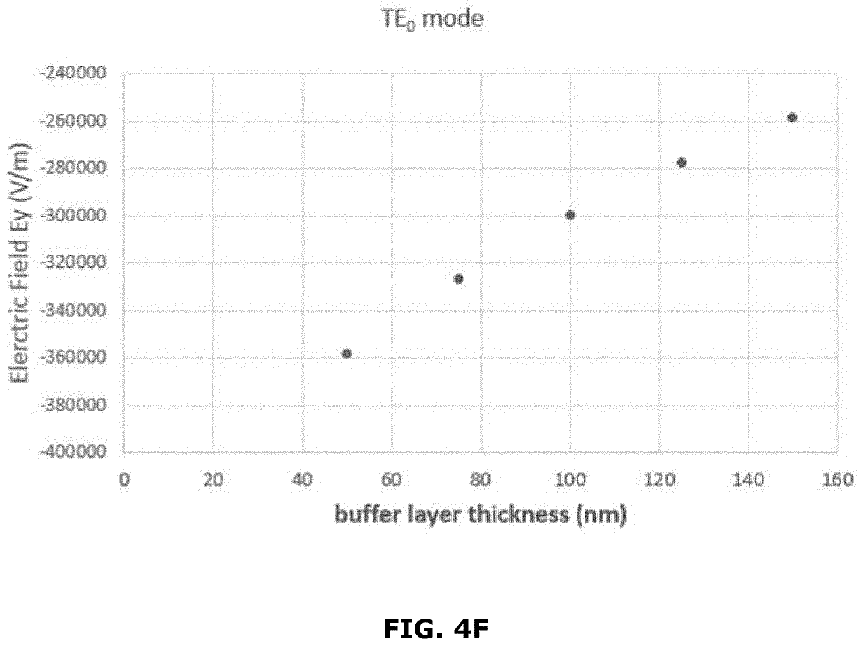

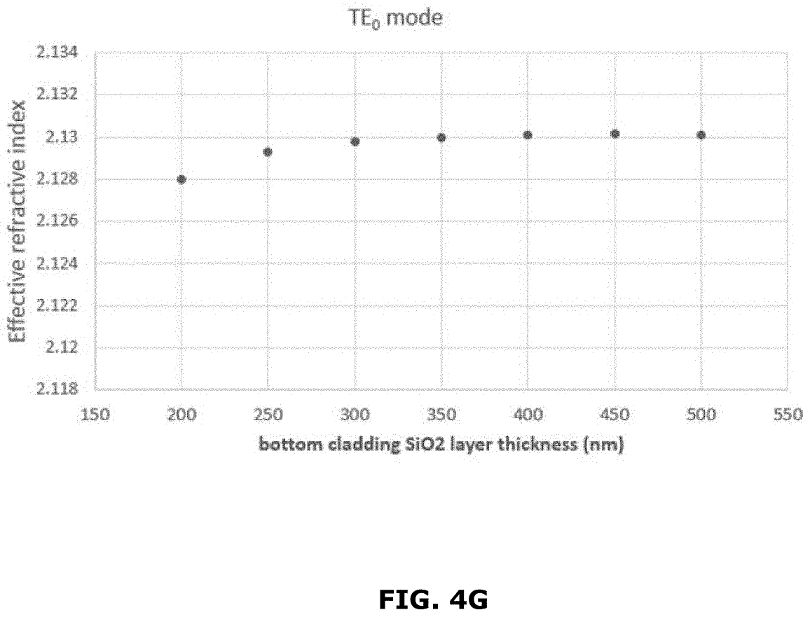

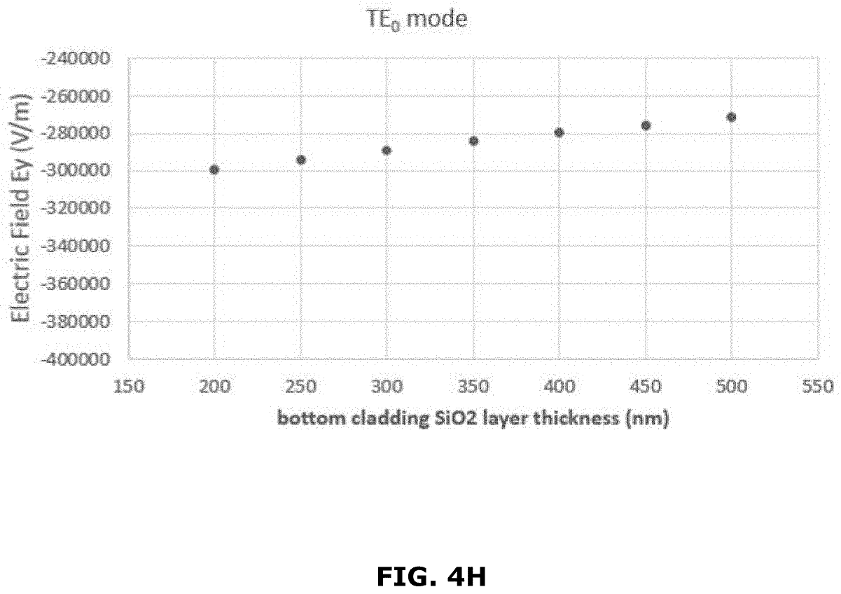

FIG. 4A illustrates a cross-sectional view 400 of an example arm of a first Z-cut LiNbO₃ electro-optic modulator, in accordance with some example embodiments. It should be appreciated that, for ease of illustration, the cross-sectional view in each of FIGS. 4A, 5, 6, 7 and 8 may show only one arm of the electro-optic modulator (or simply the “modulator”), while the modulator may have up to two arms, with both arms having the same structure or each having a different structure.

The modulator design shown in each of FIGS. 4A, 5, 6, 7 and 8 may provide a relatively large refractive index change (Δn) in the optical waveguide (or simply the “waveguide”), which may result in a relatively small half-wave voltage and the Mach Zehnder modulator's VπL. In doing so, the confinement of light is strong and the optic mode size is small. Since the nonlinear wave mixing efficiency is directly proportional to the light intensity in the waveguide, higher confinement and smaller mode size can result in a modulator with better electro-optical efficiency. Furthermore, due to a large refractive index difference, and less optical energy leakage, bending the waveguide (e.g., for optical ring resonator application) with a radius of curvature of less than a few millimeters is possible.

In addition, the proposed piezo-electro-optic modulators shown in each of FIGS. 4A, 5, 6, 7 and 8 can be CMOS compatible, which makes it possible to integrate the optical device with other electronic components on the same wafer.

Referring back to FIG. 4A, which illustrates a cross-sectional view 400 of an example arm of a first Z-cut LiNbO₃ electro-optic modulator. The modulator arm may be built on a base layer of silicon (Si) substrate (also known as the “wafer”) 450, which may also be referred to as a base substrate 450. A ground electrode 440 may be deposited on top of the Si substrate 450 and may be made of a suitable metal, which can be a metal with low electric resistance, such as gold, copper, titanium, zinc, silver, aluminum or platinum. A first cladding layer 420 may be on top of the ground electrode 440, and may be made of silicon dioxide (SiO₂). On top of the first cladding layer 420, an optical waveguide core 430 made of Z-cut LiNbO₃ may be positioned between the first cladding layer 420 and a second cladding layer 425, which may be also made of SiO₂. A signal electrode 410 may be deposited on top of the second cladding layer 425. A signal electrode may also be known as an active electrode, or an electrode with signal applied on it. The optical waveguide core 430 may include a ridge portion 435, which can also be made of Z-cut LiNbO₃. In other embodiments, the ridge portion 435 may be made of a different material other than LiNbO₃.

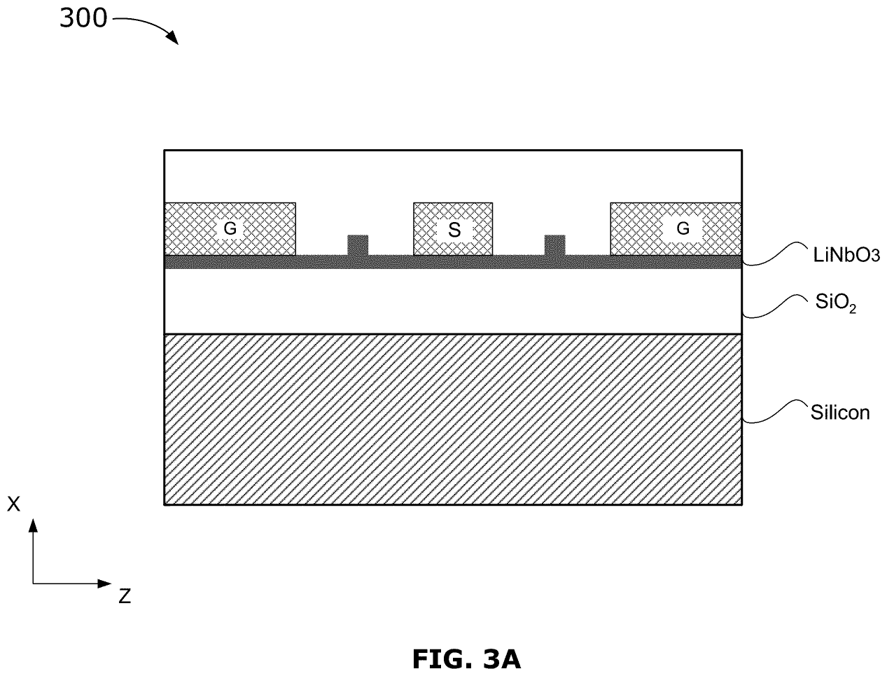

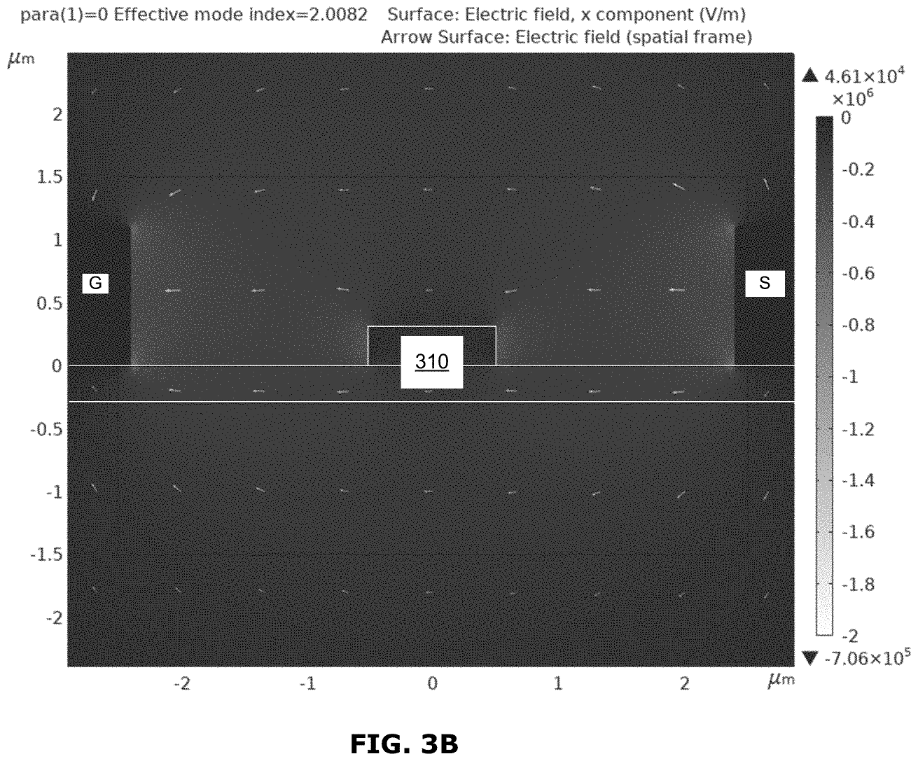

As shown in FIG. 4A, the bottom surface 415 of the signal electrode 410 and the top surface of the ground electrode 440 are spaced apart a distance t_{D}, and are each parallel to a longitudinal axis 432 of the Z-cut LiNbO₃ waveguide 430, where the longitudinal axis 432 extends through the Z-cut LiNbO₃ waveguide 430 along the x-axis of the waveguide core 430. In addition, the optical waveguide 460, which includes the waveguide core 430 and the adjacent cladding layers 420, 425, may be positioned between the signal electrode 410 and the ground electrode 440 on the z-axis of the Z-cut LiNbO₃. In comparison, in the conventional X-cut LiNbO₃ modulators, the hot and ground electrodes tend to be on the same plane with the waveguide, and at both sides of the waveguide, as shown in FIG. 3A.

The waveguide core 430 (which may include a ridge portion 435), and the immediately adjacent (or surrounding) cladding layers 420, 425 may be collectively referred to as the waveguide 460.

By placing electrodes 410, 440 on the z-axis of a Z-cut LiNbO₃, the distance between the signal-carrying electrode 410 and ground electrode 440, t_{D} may be reduced to less than 1 micrometer (μm), significantly less than the distance (4-5 μm) between electrodes aligned in the x-direction in the integrated LiNbO₃ modulators. A buffer layer 427 between the optical waveguide core 430 (including the ridge portion 435) and the signal electrode 410 may be implemented to lower the conductive loss of optical signal within the microwave electrodes. The buffer layer 427 may have a thickness t_{B}, which may be defined as a distance, along the z-axis of the Z-cut LiNbO₃, between a bottom surface 415 of the signal electrode 410 and a top surface of the optical waveguide core 430. When the optical waveguide core 430 includes a ridge portion 435 as a protruding portion of the waveguide core 430 as shown in FIG. 4A, the thickness t_{B}, may be defined as a distance, along the z-axis of the Z-cut LiNbO₃, between a bottom surface 415 of the signal electrode 410 and a top surface of the ridge portion 435.

A buffer layer thickness t_{B} that is too large may negatively affect: 1) the effective refractive index, which leads to a larger VπL; 2) the characteristic impedance Z_{C}; 3) the conductor loss α₀ (dB/(cm*GHz\hat{ }0.5)); and 4) the velocity match between RF (microwave, or millimeter wave) and optical wave. For example, as shown in FIG. 4E and FIG. 4F, when the waveguide core 430 is operating in a TE₀ mode with 1V driving voltage, as the buffer layer thickness increases from 50 nm to 130 nm while maintaining the bottom buffer layer thickness t_{S} at 200 nm, the effective refractive index of the waveguide core 430 increases from around 2.118 to 2.13, and the electric field within the waveguide core 430 decreases in magnitude from −360,000 to −260,000 V/m. Therefore, it is beneficial to keep the buffer layer 427 between the optical waveguide core 430 and the signal electrode 410 as thin as possible, preferably in the range of 50-200 nanometers (nm). Similarly, it is beneficial to keep the bottom buffer layer thickness t_{S}, which is the thickness of the SiO₂ cladding layer 420, under 600 nm. In some embodiments, the bottom buffer layer thickness may be as low as 200 nm. FIGS. 4G and 4H show that when the waveguide core 430 is operating in a TE₀ mode, as the bottom buffer layer thickness increases from 200 nm to 500 nm while keeping the top buffer layer thickness t_{B} at 100 nm, the effective refractive index of the waveguide core 430 increases from around 2.128 to 2.13, and the electric field within the waveguide core 430 decreases in magnitude from −300,000 to just above −280,000 V/m.

For the signal electrodes 410 (or also known as “data electrodes”) carrying a light signal, a positive electrical potential can be applied to one signal electrode on one of the two arms of the MZI modulator, and a negative electrical potential can be applied to the signal electrode on the other arm of the MZI modulator to obtain smallest VπL.

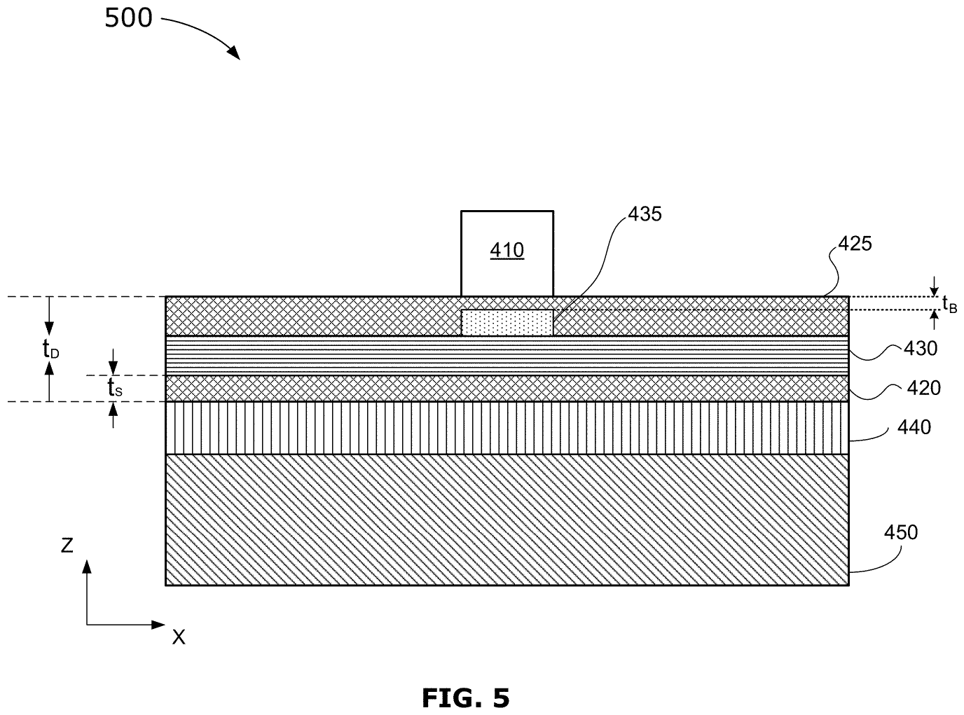

FIG. 4D illustrates a stress graph of the first example Z-cut LiNbO₃ electro-optic modulator shown in FIG. 4A, in accordance with some example embodiments. The electro-optic and stress-optic effects of the embodiment modulator shown in FIG. 4A, as well as in each of FIGS. 5 to 8 may be generally represented by the following equation:

Δ(1/n²)ᵢⱼ≡Δε⁻¹ᵢⱼ=r^{S}ᵢⱼₖEₖ+p^{E}ᵢⱼₖₗSₖₗ (1)

Where n² is the optic refractive index, r^{S} is the electro-optic tensor (Pockels) at zero strain (clamped), Sₖₗ is the strain within the optical waveguide, and p^{E} is the elasto-optic (stress-optic) tensor at constant electric field.

In the LiNbO₃ electro-optic modulator 300 shown in FIG. 3A, the strain (Sₖₗ) within the optical waveguide is minimal. In comparison, in the first example Z-cut LiNbO₃ electro-optic modulator shown in FIG. 4A, the strain Sₖₗ as indicated by the bright spot in FIG. 4D, is concentrated in and around the waveguide core 430, therefore according to equation (1) above, the contribution of the second term (p^{E}ᵢⱼₖₗ Sₖₗ) in the first example Z-cut LiNbO₃ electro-optic modulator shown in FIG. 4A is larger, as compared to the conventional LiNbO₃ electro-optic modulator 300. The modulator design shown in FIG. 4A also applies electric bias in the z-direction of the LiNbO₃ waveguide, which has the largest piezoelectric constant. This can further enhance the refractive index modulation through the stress-optic effect, as piezoelectricity leads to mechanical stress, which in turn leads to the change in optical refractive index.

From equation (1), it can be seen that a stronger electric field (Eₖ) and stronger elastic stress (Sₖₗ) can result in a stronger modulation on optic refractive index n²ᵢⱼ.

In some embodiments, when the signal electrode 410 is placed on top of the optical waveguide core 430 in the z-direction of the LiNbO₃ waveguide, and with a buffer or cladding layer 425 between the signal electrode 410 and the optical waveguide core 430 to lower the conductive loss of optical signal within the microwave electrodes, the modulation of the refractive index can be improved (i.e., increased) through stronger Pockels effect (electro-optic effect). That is, according to equation (1) above, the value of Eₖ by the first example Z-cut LiNbO₃ electro-optic modulator shown in FIG. 4A is larger, which leads to a bigger refractive index change as compared to the conventional LiNbO₃ electro-optic modulator 300.

FIG. 4B illustrates a RF electric field graph of the first example Z-cut electro-optic modulator shown in FIG. 4A when applied with a voltage of 1V, in accordance with some example embodiments. As the Z-cut LiNbO₃ waveguide 430 has the highest electro-optic coefficient along the z-axis, a very strong electric field, identified by arrows along the z-direction in the optical waveguide core 430 can be obtained. For example, within the optical waveguide core 430, there can be an electric field strength more than ten times greater than that of a conventional X-cut LiNbO₃ waveguide device.

FIG. 4C illustrates an optical power flow graph of the first example Z-cut LiNbO₃ electro-optic modulator shown in FIG. 4A when applied with a voltage of 1V, in accordance with some example embodiments. Most of the energy is shown to be contained within the optical waveguide core 430, which demonstrates that the example embodiment of the modulator design illustrated in FIG. 4A can enhance the electro-optic interaction and help to confine the optical energy within the waveguide while reducing energy leakage.

FIG. 3B illustrates a RF electric field graph of the LiNbO₃ electro-optic modulator 300 in FIG. 3A. It can be seen that the electrical field with 1V drive voltage, represented by the arrows, of the modulator in FIG. 3A point from one electrode (e.g. signal electrode “S”) to another electrode (e.g. ground electrode “G”), surrounding the waveguide core 310. The electrical field in FIG. 4B is generated with 1V drive voltage, represented by the arrows, flows from the signal electrode 410 to the ground electrode 440, but mostly concentrating within the waveguide core 430 including the ridge portion 435. Compared to that shown in FIG. 3B, it is clear that the modulator shown in FIG. 4B (which is also in FIG. 4A) is more efficient: with the same driving voltage of 1V the electric field in the optical waveguide core in FIG. 4B is much stronger than that in FIG. 3B, therefore generate much stronger modulation of optical refractive index, according to Eq.(1). In other words, it requires less driving voltage to reach the π phase shift under the same waveguide length L or it requires less waveguide length L, therefore reduce the device size, while keeping the same driving voltage. Further, as the nonlinear wave mixing efficiency is directly proportional to the light intensity in the waveguide, higher confinement and smaller mode size can result in a modulator with better electro-optical efficiency. Furthermore, due to a large refractive index difference, and less optical energy leakage, bending the waveguide (e.g., for optical ring resonator application) with a radius of curvature of less than a few millimeters is possible, by the modulator shown in FIG. 4A (as well as the modulators shown in FIGS. 5 to 8).

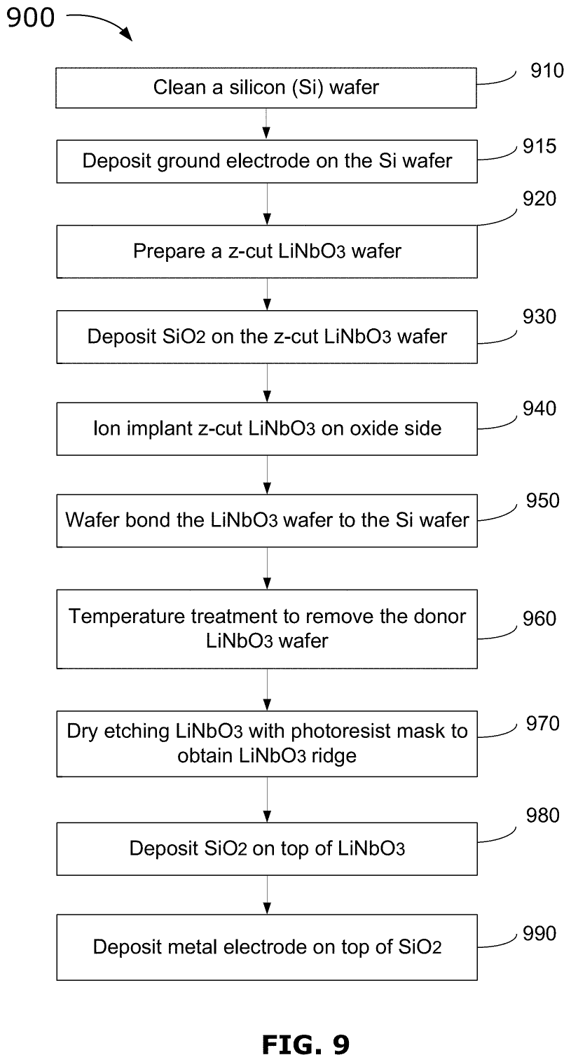

FIG. 9 illustrates a flow chart illustrating an example method 900 to manufacture the first example Z-cut LiNbO₃ electro-optic modulator shown in FIG. 4A, in accordance with some example embodiments. At step 910, a silicon (Si) base substrate or wafer 450 may be prepared and cleaned. At step 915, a metal may be deposited on the cleaned Si wafer 450 to form a ground electrode 440. The metal may be, for example, one or combination of gold, copper, titanium, zinc, silver, aluminum and platinum. At step 920, a Z-cut LiNbO₃ wafer or substrate may be prepared and cleaned. At step 930, SiO₂ may be deposited on the Z-cut LiNbO₃ wafer to form a first SiO₂ cladding layer 420. At step 940, the cleaned Z-cut LiNbO₃ wafer may be put through ion implantation with helium (He) and/or hydrogen ions on the oxide side (i.e., the side that is deposited with SiO₂ in step 930). At step 950, the side with ion implantation of the Z-cut LiNbO₃ wafer may be bonded to Si wafer on the side with ground electrode 440 of the Si wafer. At step 960 the ion-implanted LiNbO₃ may be split at the thickness damaged by the ion-implantation with a temperature treatment, leaving the part with the SiO₂ on the Si substrate, which means that the LiNbO₃ donated part of it to the bonded LiNbO₃/Si substrate, which is commonly referred to as a donor LiNbO₃ wafer layer. At step 970, the thin slice of LiNbO₃ wafer may be dry etched with photoresist mask to obtain a ridge portion 435. At step 980, SiO₂ may be deposited on top of the LiNbO₃ wafer to form a second SiO₂ cladding layer 425, surrounding the ridge portion 435. At step 990, the metal electrode 410 may be deposited on top of the SiO₂ cladding layer 425, where the metal may be, for example but not restricted to, one or combination of gold, copper, titanium, zinc, silver, aluminum and platinum.

FIG. 5 illustrates a cross-sectional view 500 of an example arm of a second example Z-cut LiNbO₃ electro-optic modulator, in accordance with some example embodiments. The modulator arm may be built on a layer of Si substrate (also known as the “wafer”) 450. A ground electrode 440 may be deposited on top of the Si substrate 450 and may be made of a suitable metal, such as gold, copper, titanium, zinc, silver, aluminum or platinum. A first cladding layer 420 may be on top of the ground electrode 440, and may be made of silicon dioxide (SiO₂). On top of the first cladding layer 420, an optical waveguide core 430 made of Z-cut LiNbO₃ may be positioned between the first cladding layer 420 and a second cladding layer 425, which may be also made of SiO₂. A signal electrode 410 may be deposited on top of the second cladding layer 425. The optical waveguide core 430 may include a ridge portion 435, which in this example embodiment may be made of tantalum pentoxide (Ta₂O₅). Ta₂O₅ is an inert material with a high refractive index, for example, it may have a refractive index of 2.1 to 2.2 in the 1550 nm range, which is close to that of LiNbO₃, which may have a refractive index of 2.21 in the same range. Ta₂O₅ may also have high dielectric constant, and low absorption. Using Ta₂O₅ to form the ridge portion 435 of the optical waveguide core 430 can overcome the difficulty of etching the LiNbO3 described above in connection with method 900. Typically the Ta₂O₅ ridge portion 435 is fabricated prior to the deposition of the second cladding of SiO₂ 425.

By placing electrodes 410, 440 on the z-axis of a Z-cut LiNbO₃, the distance between the signal-carrying signal electrode 410 and ground electrode 440, t_{D} may be reduced to less than 1 micrometer (μm), significantly less than the distance (4-5 μm) between electrodes aligned in the x-direction in the integrated LiNbO3 modulators. A buffer layer between the optical waveguide core 430 (including the ridge portion 435) and the signal electrode 410 may be implemented to lower the conductive loss of optical signal within the microwave electrodes. The buffer layer may have a thickness t_{B}, which may be defined as a distance, along the z-axis of the Z-cut LiNbO₃, between a bottom surface of the signal electrode 410 and a top surface of the optical waveguide core 430. When the optical waveguide core 430 includes a ridge portion 435 as a protruding portion of the waveguide core 430 as shown in FIG. 5, the thickness t_{B}, may be defined as a distance, along the z-axis of the Z-cut LiNbO₃, between a bottom surface of the signal electrode 410 and a top surface of the ridge portion 435.

A buffer layer thickness t_{B} that is too large may negatively affect: 1) the effective refractive index, which leads to a larger VπL; 2) the characteristic impedance Z_{C}; 3) the conductor loss α₀ (dB/(cm*GHz\hat{ }0.5)); and 4) the velocity match between RF (microwave, or millimeter wave) and optical wave. Similarly, it is beneficial to keep the bottom buffer layer thickness t_{S}, which is the thickness of the SiO₂ cladding layer 420, under 600 nm. In some embodiments, the bottom buffer layer thickness may be as low as 200 nm.

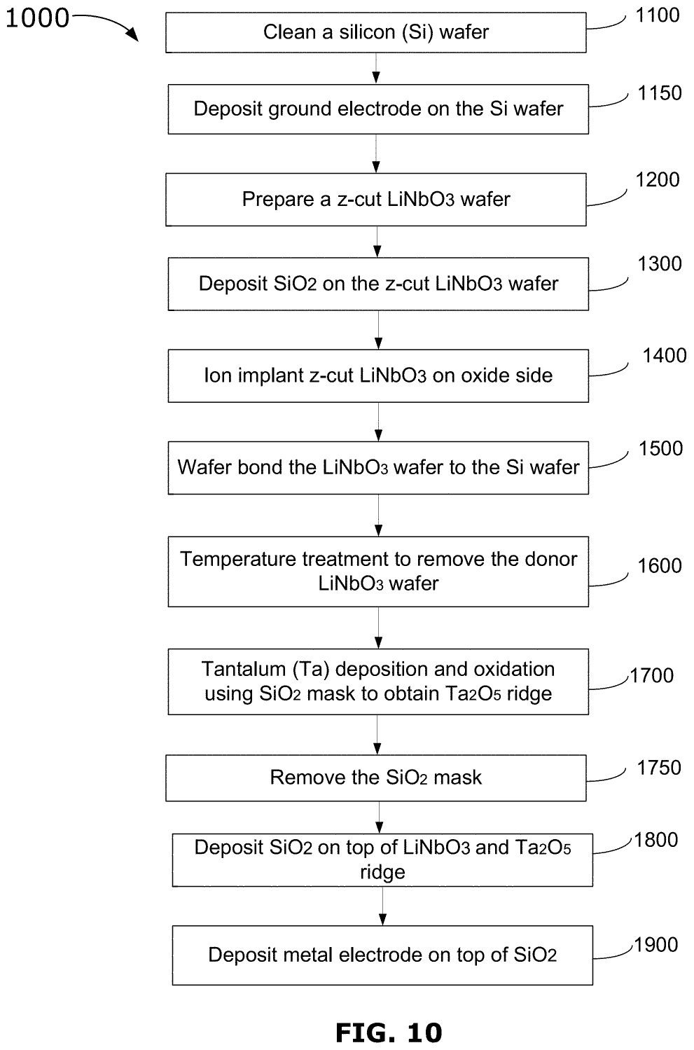

FIG. 10 is a flow chart illustrating an example method 1000 to manufacture the second example Z-cut LiNbO₃ electro-optic modulator shown in FIG. 5, in accordance with some example embodiments. At step 1100, a silicon (Si) base substrate or wafer 450 may be prepared and cleaned. At step 1150, a metal may be deposited on the cleaned Si wafer 450 to form a ground electrode 440. The metal may be, for example but not restricted to, one or combination of gold, copper, titanium, zinc, silver, aluminum and platinum. At step 1200, a Z-cut LiNbO₃ wafer or substrate may be prepared and cleaned. At step 1300, SiO₂ may be deposited on the Z-cut LiNbO₃ wafer to form a first SiO₂ cladding layer 420. At step 1400, the cleaned Z-cut LiNbO₃ wafer may be put through ion implantation with helium (He) and/or hydrogen ions on the oxide side (i.e., the side that is deposited with SiO₂ in step 1300). At step 1500, the side with ion implantation of the Z-cut LiNbO₃ wafer may be bonded to Si wafer on the side with ground electrode 440 of the Si wafer. At step 1600, temperature treatment may be carried out on the Z-cut LiNbO₃ wafer to remove the donor LiNbO₃ wafer layer, leaving behind a thin slice of LiNbO₃ wafer. At step 1700, tantalum deposition and oxidation, using a SiO₂ mask, may be carried out on the thin slice of LiNbO₃ wafer to obtain a ridge portion 435 made of Ta₂O₅. At step 1750, the SiO₂ mask may be removed, and the Ta₂O₅ ridge portion 435 remains on the LiNbO₃ wafer. At step 1800, SiO₂ may be deposited on top of the LiNbO₃ wafer to form a second SiO₂ cladding layer 425, surrounding the Ta₂O₅ ridge portion 435. At step 1900, the metal electrode 410 may be deposited on top of the SiO₂ cladding layer 425, where the metal may be, for example, one of gold, copper, titanium, zinc, silver, aluminum and platinum.

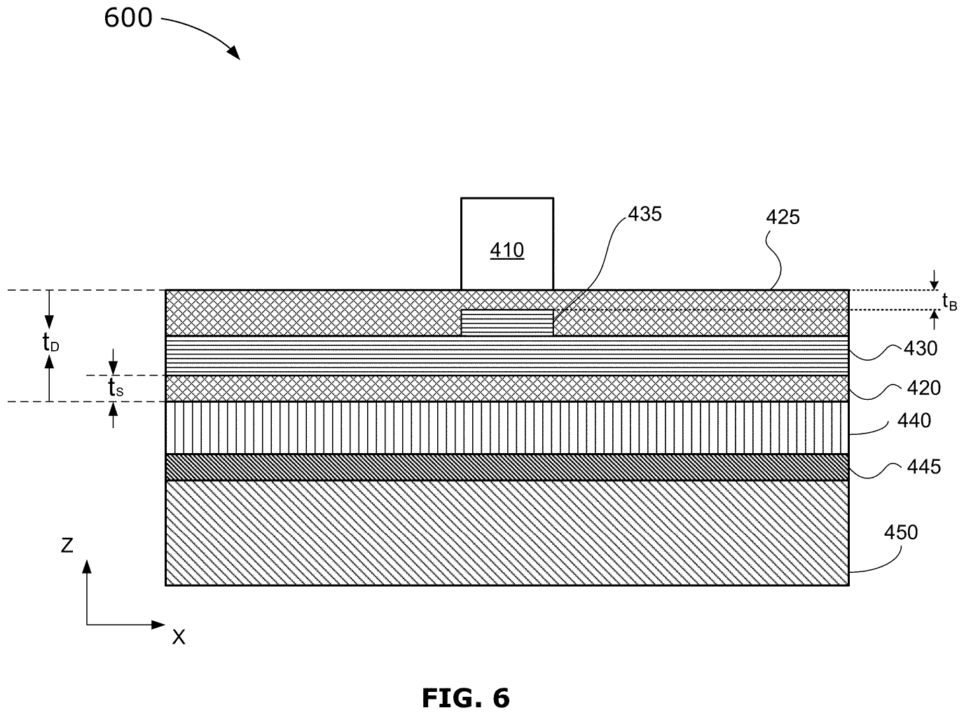

FIG. 6 illustrates a cross-sectional view 600 of an example arm of a third example Z-cut LiNbO₃ electro-optic modulator, in accordance with some example embodiments. When compared to the modulator designs in FIG. 4A and FIG. 5, this cross-sectional view 600 shows a modulator with an extra SiO₂ layer 445 between the ground electrode 440 and the Si substrate 450. The extra SiO₂ cladding layer 445 may be deposited directly on the Si substrate 450 to compensate the temperature coefficient of the LiNbO₃ optical waveguide core 430, and stable performance of the modulator in this embodiment may be obtained over a specified operating temperature range. The ridge portion 435 of the optical waveguide core 430 can either be dry etched LiNbO₃ (as in FIG. 4A) or oxidized Ta₂O₅ (as in FIG. 5). It is worth noting that the extra SiO₂ cladding layer 445 is not part of waveguide cladding (e.g. 420, 425), but a layer for temperature compensation to keep the device stable temperature-wise.

By placing electrodes 410, 440 on the z-axis of a Z-cut LiNbO₃, the distance between the signal-carrying signal electrode 410 and ground electrode 440, t_{D} may be reduced to less than 1 micrometer (μm), significantly less than the distance (4-5 μm) between electrodes aligned in the x-direction in the integrated LiNbO3 modulators. A buffer layer between the optical waveguide core 430 (including the ridge portion 435) and the signal electrode 410 may be implemented to lower the conductive loss of optical signal within the microwave electrodes. The buffer layer may have a thickness t_{B}, which may be defined as a distance, along the z-axis of the Z-cut LiNbO₃, between a bottom surface of the signal electrode 410 and a top surface of the optical waveguide core 430. When the optical waveguide core 430 includes a ridge portion 435 as a protruding portion of the waveguide core 430 as shown in FIG. 5, the thickness t_{B}, may be defined as a distance, along the z-axis of the Z-cut LiNbO₃, between a bottom surface of the signal electrode 410 and a top surface of the ridge portion 435.

A buffer layer thickness t_{B} that is too large may negatively affect: 1) the effective refractive index, which leads to a larger VπL; 2) the characteristic impedance Z_{C}; 3) the conductor loss α₀ (dB/(cm*GHz\hat{ }0.5)); and 4) the velocity match between RF (microwave, or millimeter wave) and optical wave. Similarly, it is beneficial to keep the bottom buffer layer thickness t_{S}, which is the thickness of the SiO₂ cladding layer 420, under 600 nm. In some embodiments, the bottom buffer layer thickness of the SiO₂ cladding layer 420 may be as low as 200 nm.

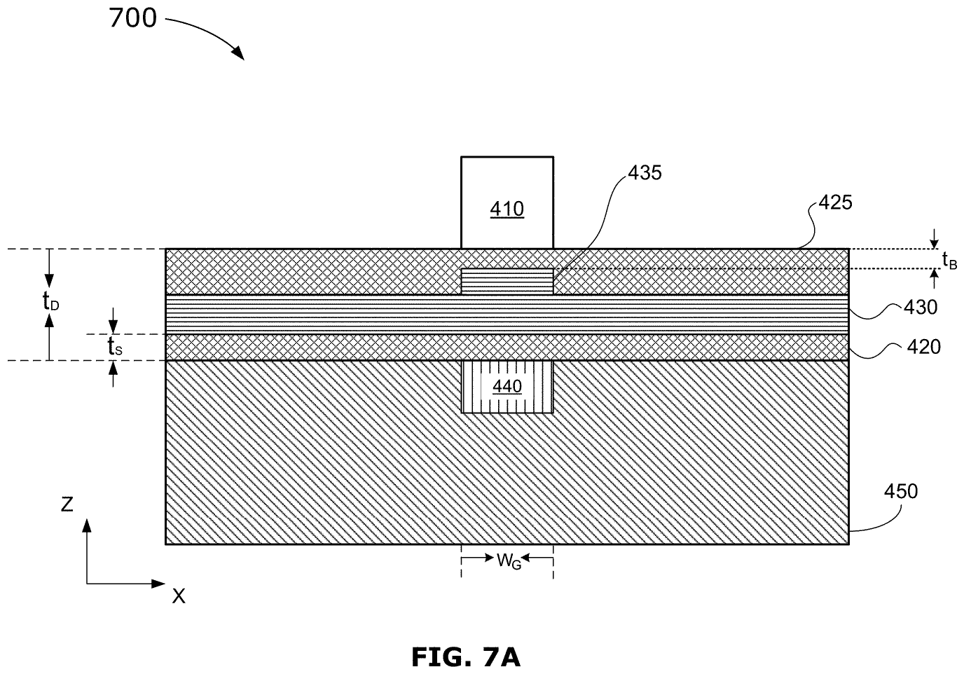

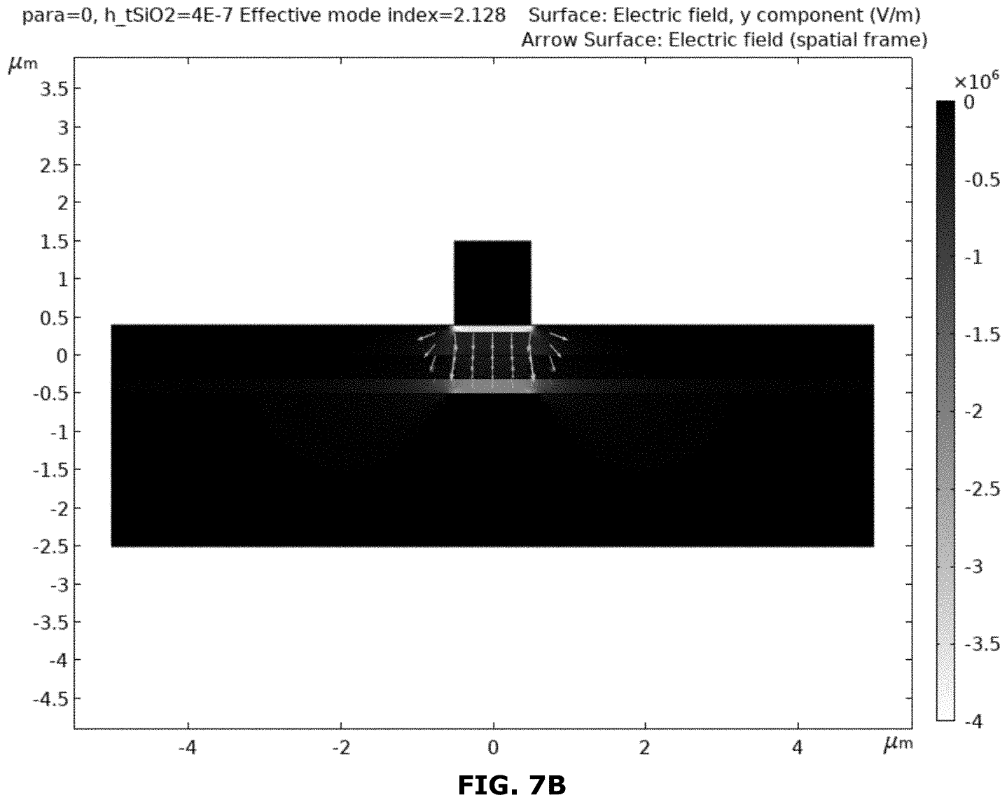

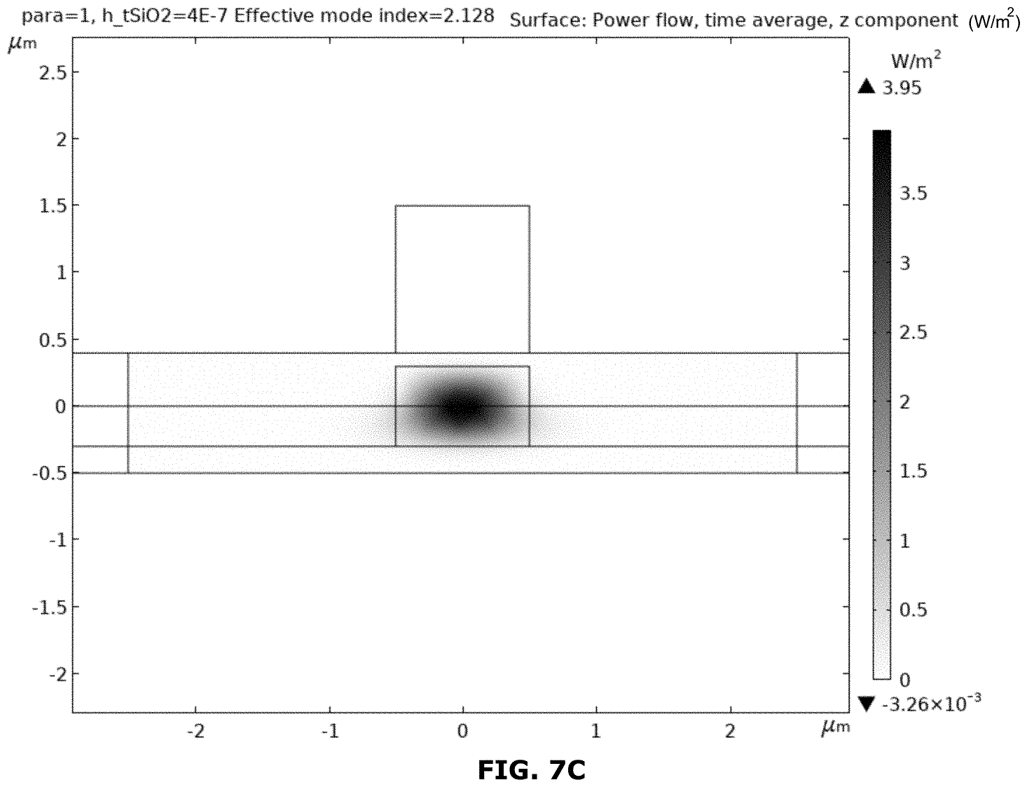

FIG. 7A illustrates a cross-sectional view 700 of an example arm of a fourth example Z-cut LiNbO₃ electro-optic modulator, in accordance with some example embodiments. When compared to the modulator designs in FIG. 4A, FIG. 5, and FIG. 6, this cross-sectional view 700 shows a modulator with a ground electrode 440 embedded within the Si substrate 450 having a much narrower width W_{G}. The ground electrode 440 in this embodiment may have a width W_{G} equal to, or around the same as, the width of the signal electrode 410. In some embodiments, the ground electrode 440 may have a width that is equal to a width of the ridge portion 435 of the optical waveguide core 430.

By placing electrodes 410, 440 on the z-axis of a Z-cut LiNbO₃, the distance between the signal-carrying signal electrode 410 and ground electrode 440, t_{D} may be reduced to less than 1 micrometer (μm), significantly less than the distance (4-5 μm) between electrodes aligned in the x-direction in the integrated LiNbO3 modulators. A buffer layer between the optical waveguide core 430 (including the ridge portion 435) and the signal electrode 410 may be implemented to lower the conductive loss of optical signal within the microwave electrodes. The buffer layer may have a thickness t_{B}, which may be defined as a distance, along the z-axis of the Z-cut LiNbO₃, between a bottom surface of the signal electrode 410 and a top surface of the optical waveguide core 430. When the optical waveguide core 430 includes a ridge portion 435 as a protruding portion of the waveguide core 430 as shown in FIG. 5, the thickness t_{B}, may be defined as a distance, along the z-axis of the Z-cut LiNbO₃, between a bottom surface of the signal electrode 410 and a top surface of the ridge portion 435.

A buffer layer thickness t_{B} that is too large may negatively affect: 1) the effective refractive index, which leads to a larger VπL; 2) the characteristic impedance Z_{C}; 3) the conductor loss α₀ (dB/(cm*GHz\hat{ }0.5)); and 4) the velocity match between RF (microwave, or millimeter wave) and optical wave. Similarly, it is beneficial to keep the bottom buffer layer thickness t_{S}, which is the thickness of the SiO₂ cladding layer 420, under 600 nm. In some embodiments, the bottom buffer layer thickness of the SiO₂ cladding layer 420 may be as low as 200 nm.

FIG. 7B illustrates a radio-frequency (RF) electric field graph of the fourth example Z-cut LiNbO₃ electro-optic modulator, while FIG. 7C illustrates an optical power flow graph of the fourth example Z-cut LiNbO₃ electro-optic modulator. Compared to the modulator shown in FIG. 4A, the electric field generated by the fourth example Z-cut LiNbO₃ electro-optic modulator is better contained within the optical waveguide core 430. The optical waveguide core 430 may be made of LiNbO₃. The ridge portion 435 of the optical waveguide core 430 can either be dry etched LiNbO₃ (as in FIG. 4A) or oxidized Ta₂O₅ (as in FIG. 5).

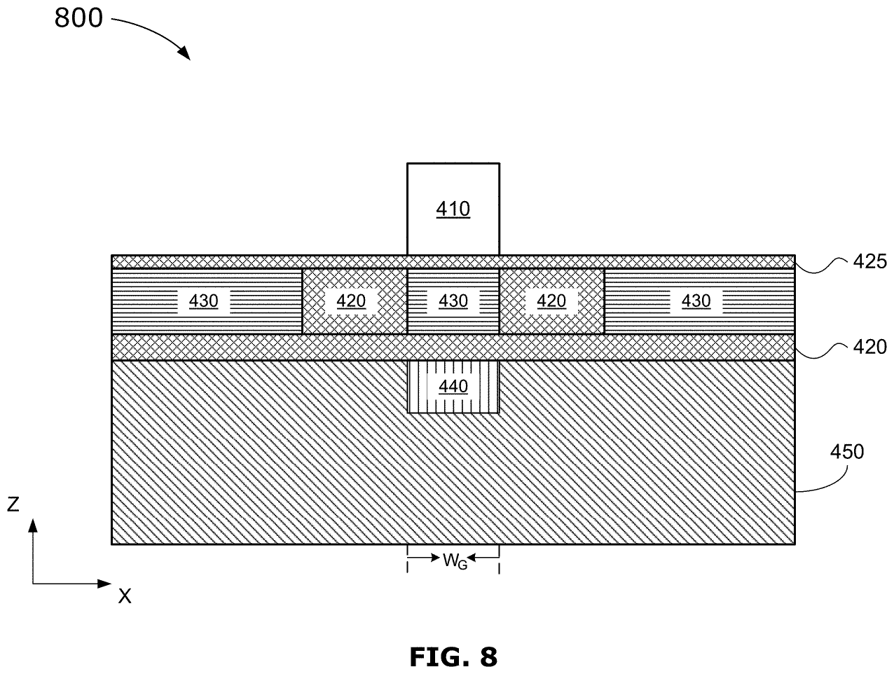

FIG. 8 illustrates a cross-sectional view 800 of an example arm of a fifth Z-cut LiNbO₃ electro-optic modulator, in accordance with some example embodiments. When compared to the modulator designs in FIG. 4A, FIG. 5, and FIG. 6, this cross-sectional view 800 shows a modulator with a ground electrode 440 embedded within the Si substrate 450 having a much narrower width W_{G}. The ground electrode 440 in this embodiment may have a width W_{G} equal to, or around the same as, the width of the signal electrode 410. In some embodiments, the ground electrode 440 may have a width that is equal to a width of the ridge portion 435 of the optical waveguide core 430.

In addition, the LiNbO₃ optical waveguide may include three individual portions, with a SiO₂ layer 420 between the first and the second portions of the LiNbO₃ optical waveguide core 430 along the x-axis of the Z-cut LiNbO₃, and another SiO₂ layer 420 between the second and the third portions of the LiNbO₃ optical waveguide core 430 along the x-axis of the Z-cut LiNbO₃.

Although the present disclosure describes methods and processes with steps in a certain order, one or more steps of the methods and processes may be omitted or altered as appropriate. One or more steps may take place in an order other than that in which they are described, as appropriate.

Certain adaptations and modifications of the described embodiments can be made. Therefore, the above discussed embodiments are considered to be illustrative and not restrictive. Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A lithium niobate (LiNbO₃)-based modulator, comprising a first arm, wherein the first arm comprises:
a base substrate;
a ground electrode deposited on the base substrate;
a first cladding layer on top of the base substrate;
an optical waveguide core on top of the first cladding layer;
a second cladding layer on top of the optical waveguide core; and
a signal electrode deposited on top of the second cladding layer;
wherein the optical waveguide core comprises a Z-cut LiNbO₃, and wherein the first cladding layer, the optical waveguide core, and the second cladding layer are positioned between the ground electrode and the signal electrode on a z-axis of the Z-cut LiNbO₃.

2. The modulator of claim 1, wherein the base substrate comprises a silicon (Si) substrate.

3. The modulator of claim 1, wherein the optical waveguide core comprises a ridge portion.

4. The modulator of claim 3, wherein the ridge portion is made of Z-cut LiNbO₃ or tantalum pentoxide (Ta₂O₅).

5. The modulator of claim 1, wherein the distance between a top surface of the ground electrode and a bottom surface of the signal electrode on the z-axis of the Z-cut LiNbO₃ is equal to or less than 1 micrometer (μm).

6. The modulator of claim 1, wherein the first cladding layer comprises silicon dioxide (SiO₂).

7. The modulator of claim 1, wherein the second cladding layer comprises silicon dioxide (SiO₂).

8. The modulator of claim 1, further comprising a third cladding layer between the ground electrode and the base substrate.

9. The modulator of claim 8, wherein the third cladding layer comprises silicon dioxide (SiO₂).

10. The modulator of claim 1, wherein the ground electrode is embedded within the base substrate.

11. The modulator of claim 10, wherein the ground electrode has a width that is equal to a width of the signal electrode.

12. The modulator of claim 3, wherein the ground electrode has a width that is equal to a width of the ridge portion of the optical waveguide.

13. The modulator of claim 1, wherein a distance between a bottom surface of the signal electrode and a top surface of the optical waveguide core is between 50 nanometers (nm) to 200 nm.

14. The modulator of claim 1, wherein a thickness of the first cladding layer is between 200 nm to 600 nm.

15. The modulator of claim 1, comprising a second arm, wherein the second arm comprises:
the first base substrate;
a second ground electrode deposited on the first base substrate;
a third cladding layer on top of the first base substrate;
a second optical waveguide core on top of the third cladding layer;
a fourth cladding layer on top of the second optical waveguide; and
a second signal electrode deposited on top of the fourth cladding layer;
wherein the second optical waveguide core comprises a second Z-cut LiNbO₃, and wherein the third cladding layer, the second optical waveguide, and the fourth cladding layer are positioned between the second ground electrode and the second signal electrode on a z-axis of the second Z-cut LiNbO₃.

16. The modulator of claim 15, wherein the second optical waveguide core comprises a ridge portion made of Z-cut LiNbO₃ or tantalum pentoxide (Ta₂O₅).

17. The modulator of claim 15, wherein the distance between a top surface of the second ground electrode and a bottom surface of the second signal electrode on the z-axis of the second Z-cut LiNbO₃ is equal to or less than 1 micrometer (μm).

18. The modulator of claim 15, wherein a distance between a bottom surface of the second signal electrode and a top surface of the second optical waveguide core is between 50 nanometers (nm) to 200 nm.

19. The modulator of claim 15, wherein a thickness of the third cladding layer is between 200 nm to 600 nm.

20. The modulator of claim 15, wherein the second ground electrode is embedded within the first base substrate.
